(19) United States
(12) Patent Application Publication
(10) Pub. No.: US 2009/0046397 A1
(43) Pub. Date: Feb. 19, 2009

(54) METHODS AND APPARATUS FOR A SYNTHETIC ANTI-FERROMAGNET STRUCTURE WITH IMPROVED THERMAL STABILITY

(75) Inventors: Jijun Sun, Chandler, AZ (US); Renu W. Dave, Chandler, AZ (US); Jon M. Slaughter, Tempe, AZ (US)

Correspondence Address: INGRASSIA FISHER & LORENZ, P.C. (FS), 7010 E. COCHISE ROAD, SCOTTSDALE, AZ, 85253, US

(73) Assignee: FREESCALE SEMICONDUCTOR, INC., Austin, AZ (US)

(21) Appl. No.: 11/839,044

(22) Filed: Aug. 15, 2007

(51) Int. Cl. H01F 10/00

(52) U.S. Cl. 360/324.11

(57) ABSTRACT

A synthetic antiferromagnet (SAF) structure includes a bottom ferromagnetic layer, a coupling layer formed over the bottom ferromagnetic layer, and a top ferromagnetic layer formed over the coupling layer. One of the top and bottom ferromagnetic layers comprises an amorphous alloy characterized by (Co₁₀₀₋ₐFeₐ)_{100-z}B_{z}, where a is less than approximately 10 atomic percent, and z is greater than approximately 20 atomic percent. In general, a magnetic device includes at least one magnetic layer comprising an amorphous CoFeB alloy characterized by (Co₁₀₀₋ₐFeₐ)_{100-z}B_{z}, where a is less than approximately 10 atomic percent, and z is greater than approximately 20 atomic percent.

### TECHNICAL FIELD

The present invention relates generally to magneto-resistive device structures and, more particularly, to magnetoresistive devices with an improved synthetic anti-ferromagnet (SAF) structure.

### BACKGROUND

Magneto-electronic devices such as magnetoresistive random access memory (MRAM) cells, magnetic sensors, read-heads and the like have become increasingly popular in recent years due to the large signal available from recently-developed magnetoresistive materials. In this regard, MRAM has the advantages of nonvolatile storage, radiation resistance, fast read and write operations, and high endurance compared to other nonvolatile memories. Such devices typically incorporate a magnetic tunnel junction (MTJ) structure (or “stack”) that includes multiple ferromagnetic layers separated by one or more non-magnetic layers. A typical MTJ stack might include one or two synthetic anti-ferromagnets (SAFs), such as a single free layer and a pinned SAF, or a free-layer SAF and a pinned SAF.

One property of a SAF, which is related to the switching or toggle field, is the strength of the antiferromagnetic coupling between the two layers, which is characterized by the saturation field of the SAF material, Hₛₐₜ. It is known that for NiFe SAFs with a Ru spacer layer thickness in the typical range of 7 Å to 10 Å, the SAF structure begins to fail at temperatures above approximately 275° C., resulting in poor switching behavior. The MR of an MTJ material having NiFe-based SAF free layers also degrades for temperatures above approximately 275° C. due to SAF failure as well other mechanisms. Thus, it is desirable to use a SAF structure that can withstand temperatures over 350° C. to allow high-temperature processes for circuit fabrication as well as high-temperature anneals needed to obtain high MR with MgO tunnel barrier material.

The uniaxial anisotropy of the material also affects the switching field of the bit and the size of the toggle operating window. Hence the SAF material is preferably chosen to produce the optimum uniaxial anisotropy. For MRAM devices with significant shape anisotropy, it is desirable to minimize the anisotropy of the material to keep the switching field low and the operating window large. The uniaxial anisotropy of the material is expressed as the kink field Hₖ—i.e., the field needed to saturate the magnetic moment of that material along the hard axis.

If a ferromagnetic material has significant magnetostriction, its anisotropy will generally be affected by stress and strain. Since it is advantageous for the anisotropy to be fixed and controlled for MRAM devices, it is desirable to control and minimize magnetostriction of the free layer material. For uniform and repeatable switching, the magnitude of the magnetostriction constant λ should be approximately 1×10⁻⁶ or less, that is, −1×10⁻⁶<λ1×10⁻⁶.

Accordingly, it is desirable to provide a MTJ stack with improved thermal stability for tunneling magnetoresistance and magnetic properties, low magnetostriction, and low uniaxial anisotropy. Furthermore, other desirable features and characteristics of the present invention will become apparent from the subsequent detailed description and the appended claims, taken in conjunction with the accompanying drawings and the foregoing technical field and background.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a cross-sectional overview of an exemplary magnetic tunnel junction stack;

FIG. 2 is a cross-sectional overview of a synthetic anti-ferromagnet as shown in FIG. 1 in accordance with one embodiment;

FIG. 3 is a cross-sectional overview of a particular SAF embodiment in accordance with FIG. 2;

FIGS. 4-7 depict various characteristics of SAFs incorporating exemplary alloy compositions; and

FIGS. 8-11 depict various characteristics of exemplary SAFs as a function of anneal temperature.

### DETAILED DESCRIPTION

The following detailed description is merely exemplary in nature and is not intended to limit the range of possible embodiments and applications. Furthermore, there is no intention to be bound by any theory presented in the preceding background or the following detailed description.

For simplicity and clarity of illustration, the drawing figures depict the general structure and/or manner of construction of the various embodiments. Descriptions and details of well-known features and techniques may be omitted to avoid unnecessarily obscuring other features. Elements in the drawings figures are not necessarily drawn to scale: the dimensions of some features may be exaggerated relative to other elements to improve understanding of the example embodiments.

Terms of enumeration such as “first,” “second,” “third,” and the like may be used for distinguishing between similar elements and not necessarily for describing a particular spatial or chronological order. These terms, so used, are interchangeable under appropriate circumstances. The embodiments of the invention described herein are, for example, capable of use in sequences other than those illustrated or otherwise described herein. Unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The terms “comprise,” “include,” “have” and any variations thereof are used synonymously to denote non-exclusive inclusion. The term “exemplary” is used in the sense of “example,” rather than “ideal.”

For the sake of brevity, conventional techniques related to semiconductor processing (e.g., physical vapor deposition (PVD), ion beam deposition (IBD), etc) as well as the operation of conventional magnetoresistive random access memories (MRAMs) and Magnetic Tunnel Junctions (MTJs) may not be described in detail herein. It should be noted that many alternative or additional functional relationships or physical connections may be present in a practical embodiment.

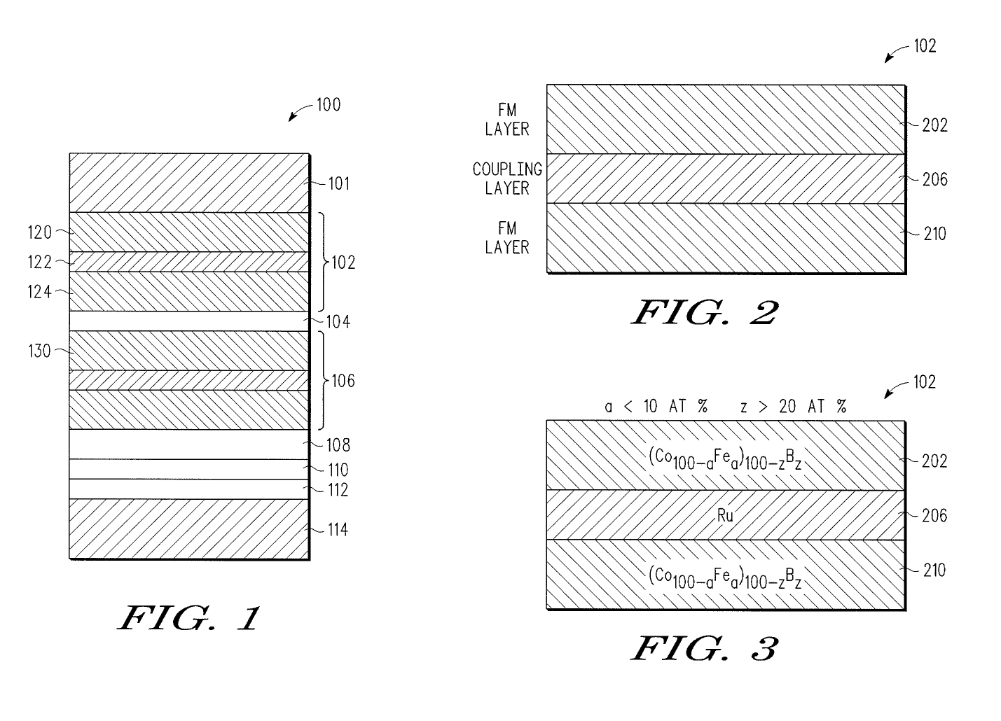

Referring now to FIGS. 1 and 2, a magnetic tunnel junction (MTJ) 100 useful in describing the present invention generally includes a top electrode 101, a free-layer synthetic anti-ferromagnet (or “SAF”) 102 (which might alternatively be a single layer), a pinned SAF 106, a dielectric layer (e.g., AlOₓ) 104 separating SAF 102 from SAF 106, an anti-ferromagnetic pinning layer 108, a template layer 110, a seed layer 112, and a second electrode (or “base electrode”) 114. As is known, the orientation of free-layer SAF 102 may be switched so that the ferromagnetic layer 124 next to the tunneling barrier can be configured parallel or anti-parallel with respect to the fixed layer 130 in pinned SAF 106 (which is pinned by pinning layer 108), thus providing two resistive states that can be stored and read in connection with a memory device.

An exemplary free layer SAF 102 (FIG. 2) in accordance with one embodiment generally includes a bottom ferro-magnetic layer (or “FM-layer”) 210, a coupling layer (or “spacer”) 206, and a topmost FM-layer 202. Various other layers, such as insertion layers (not illustrated) between coupling layer 206 and FM-layers 210 and 202, or between tunnel barrier layer 104 and FM layer 124, may also be included in this stack for enhancing coupling strength and other magnetic properties or electrical properties such as MR.

Coupling layer 206 may include any of the various materials traditionally used in connection with magneto-resistive devices. In one embodiment, for example, coupling layer 206 is a layer of ruthenium having a thickness of between approximately 8 Å and 25 Å. A number of other materials may be used, however, including rhodium, chromium, vanadium, molybdenum, etc as well as alloys of these materials, such as ruthenium-tantalum, and the like.

As previously mentioned, it is desirable to increase the operating temperature range of SAF 102 while maintaining desirable magnetic properties, e.g.—a low uniaxial anisotropy (Hₖ) produced by a substantially magnetostriction-free layer that minimizes switching distribution. In one embodiment, both FM layers 202 and 210 comprise an amorphous alloy that exhibits low Hₖ and low magnetostriction.

In a particular embodiment, FM layer 202 and FM layer 210 comprise an amorphous alloy comprising cobalt, iron, and boron (CoFeB) whose ratios are selected to achieve the desired magnetic properties. In a particular embodiment, FM layer 202 and FM layer 210 both comprise of an alloy characterized as (Co₁₀₀₋ₐFeₐ)_{100-z}B_{z}, where a is less than approximately 10 atomic percent, and z is greater than approximately 20 atomic percent. In a particular embodiment, z is between about 23-30 atomic %, which the present inventors have found is effective for lowering Hₖ and improving thermal stability of both MR and coupling strength of the SAF free layer. MTJ structures incorporating such amorphous alloys enable MRAM devices with improved speed, reduced error rate, and improved thermal stability.

The thicknesses of the various layers in the MTJ stack may be selected in order to achieve the desired electrical and/or magnetic characteristics. More generally, it is known that the layers of the MTJ stack may be adjusted to arrive at a preferred level of magnetostriction. Thus, the thickness of layers 202 and 210 may vary depending upon the application. In one embodiment, for example, layers 202 and 210 are each between 15 Å and 50 Å, for example, approximately 30 Å.

Empirical results for various alloy compositions are, for illustrative purposes, shown in FIGS. 4-11. The various coefficients and other values depicted in these graphs are not intended to limit the present invention in any way.

FIG. 4, for example, shows anisotropy field Hₖ and coercivity H_{c} along the easy axis for a structure of CoₓFe_{y}B_{z}30/CoFe2.5/Ru14/CoₓFe_{y}B_{z} 41, where CoₓFe_{y}B_{z} (or (Co₁₀₀₋ₐFeₐ)_{100-z}B_{z}) alloys with various compositions fabricated by co-sputtering films (PVD) from two different targets. FIG. 5 shows the anisotropy field Hₖ and coercivity H_{c} along the easy axis for a structure of CoₓFe_{y}B_{z}40/CoFe2.5/Ru13/CoFe2.5/CoₓFe_{y}B_{z} 40, where CoₓFe_{y}B_{z} (or (Co₁₀₀₋ₐFeₐ)_{100-z}B_{z}) alloys with various compositions fabricated by multilayering films from two different targets (IBD).

The data presented in the foregoing figures relates to trilayer structures similar to SAFs, but with a slightly thicker Ru layer to make them ferromagnetically coupled for measurement of magnetic properties. By using this measurement method, it is possible to find the magnetic properties of the SAF material, which is different from that of simple thin films of the given alloys due to the presence of the ruthenium and the very thin films used for testing. In this way, the alloys can be optimized for SAF properties and toggle switching. One or two insertion layers at either one side or two sides of the Ru coupling layer have been incorporated into the SAF structure for optimizing the SAF structures with appropriate Hₛₐₜ at or temperature coefficient (TC) (which is a measure of how Hₛₐₜ or the switching field change with operating temperature.) Insertion layers are typically selected from a group of alloys comprising CoFe, CoFeB, or other alloys containing Co and Fe.

As can be seen, Hₖ is generally reduced by increasing the B content (z). Hₖ achieves values less than about 15 Oe when z is over about 20.0 atomic %, and can be as low as 7.0 Oe when z is over about 25%. The Hₖ change is relatively small when z is less than 8-11%, where the transition of amorphous to crystalline phase occurs and is dependent on Fe content y. Furthermore, as shown in FIG. 4, H_{c} increases quickly when z is less than about 10% (FIG. 4) due to the phase transition of CoFeB from amorphous to crystalline. However, the increase of H_{c} is not as abrupt at the amorphous-to-crystalline phase transition (at about 13% B, confirmed by XRD) when Fe content y is only a few percent (see FIG. 5).

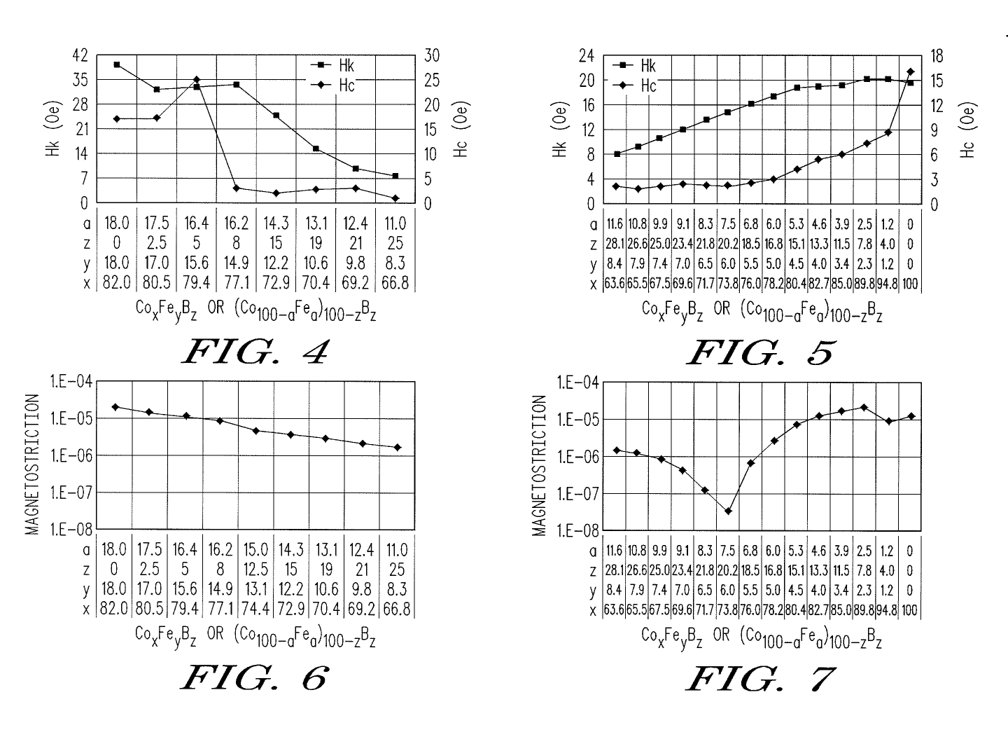

FIG. 6 shows magnetostriction for the same samples illustrated in FIG. 4, with various compositions of CoFeB alloys formed by co-sputtering films from two different targets (PVD). Similarly, FIG. 7 shows magnetostriction for the same samples illustrated in FIG. 5 with various compositions of CoFeB alloys by multilayering films from two different targets (IBD). As can be seen, magnetostriction of less than 1.5E-6 is obtained for Co_{66.8}Fe_{8.3}B₂₅ amorphous alloys (FIG. 6) and a minimum value of magnetostriction occurs when Fe content y is about 6.0% and B content z is about 20.0% (as shown in FIG. 7)—resulting in a magnetostriction value as low as 5E-8. The magnetostriction of the pure Co alloy in FIG. 7 is denoted by “-” and is shown as an open diamond. Taking the data from both figures into consideration, it is apparent that the magnetostriction is primarily dependent on the iron content a of the base Co₁₀₀₋ₐFeₐ alloy. Combining the trends of Hₖ and magnetostriction with B and Fe content, amorphous CoFeB alloys will have low magnetostriction (on the order of 1E-8˜1E-7) with Hₖ less than 10 Oe when Fe content y is in the range of 7.5-5.0% (or a=9.9-6.0%) and B content z is over 20%.

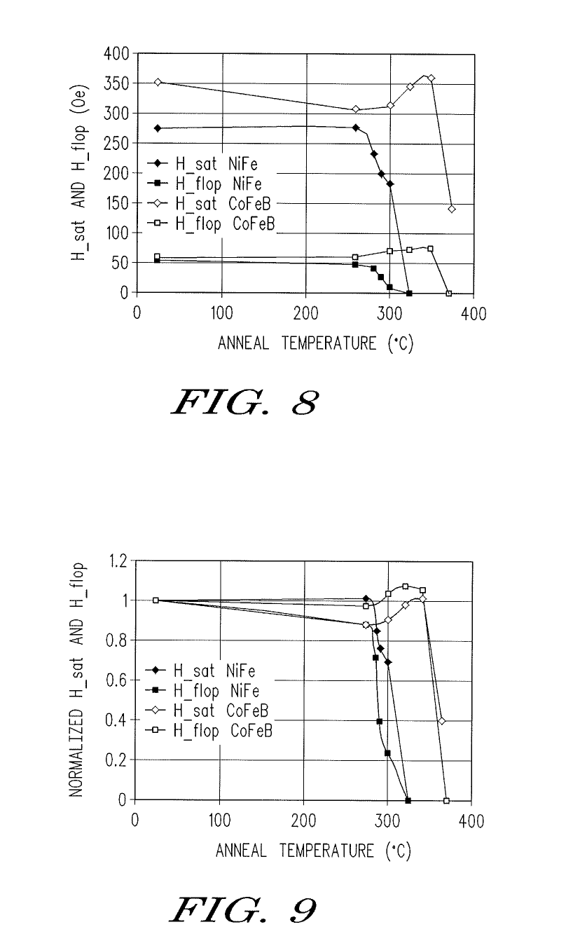

FIGS. 8-9 show Hsat and flop field H_flop as a function of anneal temperature for both NiFe SAF free layers and CoFeB SAF free layers, where CoFeB alloys have a composition CoFe8.4B28 and fabricated via IBD. For NiFe SAFs, Hₛₐₜ starts to drop as anneal temperature increases to 285° C. There no Hₛₐₜ when it is annealed at 3250C. Although there is still anti-ferromagnetic coupling (small Hₛₐₜ) after annealing at 300° C., the flop field H_flop is very small, which is easy to disturb. However, anti-ferromagnetic coupling remains for CoFeB SAFs even after annealed at 375° C. Hₛₐₜ is slightly increased when anneal temperature in the range of 300-350° C. compared with that at 265° C. Normalized results in FIG. 9 shows that both Hₛₐₜ and H_{flop} for CoFeB SAFs disappear at ˜50° C. higher anneal temperature than that for NiFe SAFs, indicating that the CoFeB SAFs have better thermal stability than NiFe SAFs.

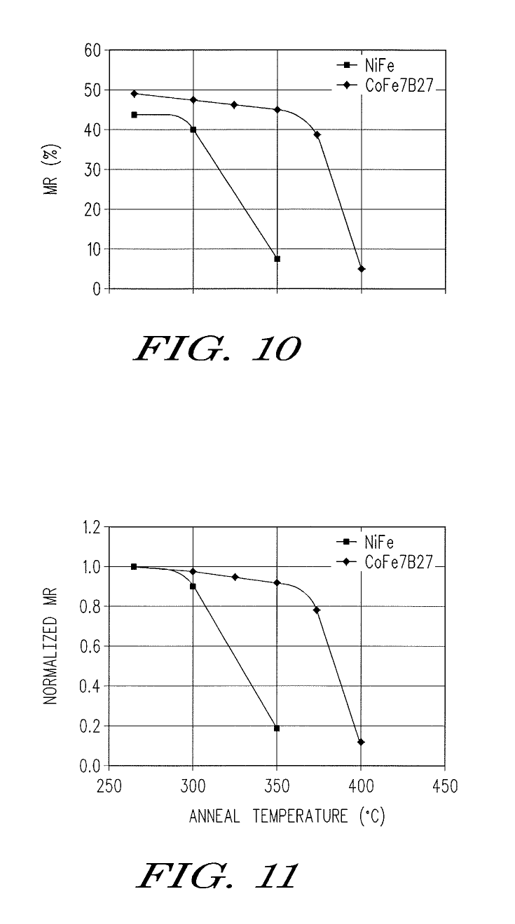

FIG. 10 compares MR as a function of anneal temperature for both a NiFe SAF free layer and CoFeB SAF free layer. The particular CoFeB composition illustrated is CoFe_{8.4}B₂₈; however, the invention is not so limited. FIG. 11 shows normalized plots corresponding to FIG. 10.

It can be seen that MR decreases faster in the NiFe free layer than the CoFeB free layer. For the NiFe free layer, MR drops more than 80% in an MTJ after it is annealed at 350° C., while MR only drops about 10% for a MTJ with a CoFeB free layer after being annealed at the same temperature. For the CoFeB free layer, MR only decreases about 20% for an anneal temperature up to 375° C., then drops quickly as anneal temperature is further increased up to 400° C.

With a CoFeB single free layer instead of a CoFeB SAF free layer, the similar dependence of MR on anneal temperature is obtained. Furthermore, the magnetic properties (such as H_{c} and Hₖ) has been stable for these amorphous CoFeB alloys after anneal at 350° C. This indicates that an MTJ device with amorphous CoFeB as a single free layer exhibits better thermal stability of MR than that of a NiFe free layer, and still retains good magnetic properties, which is important for other magneto-electronic devices, such as magnetic sensors and hard-disk drives. With recently-developed MgO tunneling barriers, which require high temperature anneal for high MR, these thermally stable amorphous CoFeB alloys are very good candidates as a free layer in MgO-based MTJ.

As discussed above, a SAF free layer with CoFeB amorphous alloys has been disclosed. A structure with CoFe₅₋₆B₂₅₋₂₈/CoFe (or CoFeB)/Ru/CoFe (or CoFeB)/CoFe₅₋₆B₂₅₋₂₈ has been optimized for toggle switching in MRAM devices. The CoFe₅₋₆B₂₅₋₂₈ amorphous alloy minimizes the magnetostriction of the SAF free layer, reducing Hₖ and improving thermal stability of both MR and Hₛₐₜ for the SAF free layer. Insertion layers of CoFe or CoFeB are used to control Hₛₐₜ or improve temperature coefficient of Hsat (or switching field).

While the present invention describes exemplary SAFs in the context of MRAM devices, the range of embodiments is not limited to these applications. Methods and structures disclosed herein may be used, for example, in magnetic sensors, hard-disk drives, and the like.

In general, what has been described is a synthetic anti-ferromagnet (SAF) structure comprising: a bottom ferromagnetic layer; a coupling layer formed over the bottom ferromagnetic layer; and a top ferromagnetic layer formed over the coupling layer, wherein at least one of the top and bottom ferromagnetic layers comprises an amorphous CoFeB alloy characterized by (Co₁₀₀₋ₐFeₐ)_{100-z}B_{z}, where a is less than approximately 10 atomic percent, and z is greater than approximately 20 atomic percent. In one embodiment, z is between approximately 23 and 30 atomic percent. In another, the SAF structure is configured to provide a uniaxial anisotropy such that the kink field Hₖ is less than approximately 16 Oe. In yet another, the SAF structure exhibits a magnetostriction λ, where λ is in the range of −1×10⁶<λ<1×10⁶. In a particular embodiment, the bottom ferromagnetic layer has a thickness greater than approximately 20 Å, and the second ferromagnetic layer has a thickness greater than approximately 20 Å. The coupling layer may, for example, be ruthenium.

In accordance with another embodiment, a magnetic tunnel junction (MTJ) structure comprises: a first electrode; a pinned synthetic anti-ferromagnet (SAF) formed over the first electrode; a free-layer SAF formed over the pinned SAF; a dielectric layer formed between the free-layer SAF and the pinned SAF; a top electrode formed over the free-layer SAF; wherein the free-layer SAF comprises a bottom ferromagnetic layer, a coupling layer formed over the bottom ferromagnetic layer, and a top ferromagnetic layer formed over the coupling layer, wherein at least one of the top and bottom ferromagnetic layers comprises an amorphous CoFeB alloy characterized by (Co₁₀₀₋ₐFeₐ)_{100-z}B_{z}, where a is less than approximately 10 atomic percent, and z is greater than approximately 20 atomic percent. In one embodiment, z is between approximately 23 and 30 atomic percent. In another, the free-layer SAF is configured to provide a uniaxial anisotropy such that a kink field Hₖ is less than approximately 16 Oe. The free-layer SAF may exhibit a magnetostriction λ in the range of −1×10⁻⁶<λ<1×10⁻⁶. In a particular embodiment, the bottom ferromagnetic layer has a thickness greater than approximately 20 Å, and the second ferromagnetic layer has a thickness greater than approximately 20 Å.

A method of fabricating a synthetic antiferromagnet comprises: forming a bottom ferromagnetic layer; forming a coupling layer over the bottom ferromagnetic layer; and forming a top ferromagnetic layer over the coupling layer; wherein forming the top and bottom ferromagnetic layers includes forming an amorphous CoFeB alloy characterized by (Co₁₀₀₋ₐFeₐ)_{100-z}B_{z}, where a is less than approximately 10 atomic percent, and z is greater than approximately 20 atomic percent. In one embodiment, z is between approximately 23 and 30 atomic percent. The free-layer SAF structure may be configured to provide a uniaxial anisotropy such that a kink field Hₖ is less than approximately 16 Oe. Forming the bottom and top ferromagnetic layers may include co-sputtering films using physical vapor deposition (PVD) utilizing at least two different targets, or ion-beam deposition (IBD).

In accordance with another embodiment, a magnetic device includes at least one magnetic layer comprising an amorphous CoFeB alloy characterized by (Co₁₀₀₋ₐFeₐ)_{100-z}B_{z}, where a is less than approximately 10 atomic percent, and z is greater than approximately 20 atomic percent.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A synthetic anti-ferromagnet (SAF) structure comprising:
a bottom ferromagnetic layer;
a coupling layer formed over the bottom ferromagnetic layer; and
a top ferromagnetic layer formed over the coupling layer;
wherein at least one of the top and bottom ferromagnetic layers comprises an amorphous CoFeB alloy characterized by (Co₁₀₀₋ₐFeₐ)_{100-z}B_{z}, where a is less than approximately 10 atomic percent, and z is greater than approximately 20 atomic percent.

2. The SAF structure of claim 1, wherein z is between approximately 23 and 30 atomic percent.

3. The SAF structure of claim 1, wherein the SAF structure is configured to provide a uniaxial anisotropy such that the kink field Hₖ of the bottom and top ferromagnetic layers is less than approximately 16 Oe.

4. The SAF structure of claim 1, wherein the bottom and top ferromagnetic layers exhibit a magnetostriction λ, where λ is in the range of −1×10⁻⁶<λ<1×10⁻⁶.

5. The structure of claim 1, wherein the bottom ferromagnetic layer has a thickness greater than approximately 20 Å, and the second ferromagnetic layer has a thickness greater than approximately 20 Å.

6. The structure of claim 1, wherein the coupling layer is ruthenium.

7. A magnetic tunnel junction (MTJ) structure comprising:
a first electrode;
a pinned synthetic anti-ferromagnet (SAF) formed over the first electrode;
a free-layer SAF formed over the pinned SAF;
a dielectric layer formed between the free-layer SAF and the pinned SAF;
a top electrode formed over the free-layer SAF;
wherein the free-layer SAF comprises a bottom ferromagnetic layer, a coupling layer formed over the bottom ferromagnetic layer, and a top ferromagnetic layer formed over the coupling layer, wherein at least one of the top and bottom ferromagnetic layers comprises an amorphous CoFeB alloy characterized by (Co₁₀₀₋ₐFeₐ)_{100-z}B_{z}, where a is less than approximately 10 atomic percent, and z is greater than approximately 20 atomic percent.

8. The MTJ structure of claim 7, wherein z is between approximately 23 and 30 atomic percent.

9. The MTJ structure of claim 7, wherein the free-layer SAF is configured to provide a uniaxial anisotropy such that a kink field Hₖ of the top and bottom ferromagnetic layers is less than approximately 16 Oe.

10. The MTJ structure of claim 7, wherein the bottom and top ferromagnetic layers exhibit a magnetostriction λ, where λ is in the rang of −1×10⁻⁶<λ<1×10⁻⁶.

11. The MTJ structure of claim 7, wherein the bottom ferromagnetic layer has a thickness greater than approximately 20 Å, and the second ferromagnetic layer has a thickness greater than approximately 20 Å.

12. The MTJ structure of claim 7, wherein the coupling layer is ruthenium.

13. A method of fabricating a synthetic antiferromagnet (SAF) comprising:
forming a bottom ferromagnetic layer;
forming a coupling layer over the bottom ferromagnetic layer; and
forming a top ferromagnetic layer over the coupling layer;
wherein forming the top and bottom ferromagnetic layers includes forming an amorphous CoFeB alloy characterized by (Co₁₀₀₋ₐFeₐ)_{100-z}B_{z}, where a is less than approximately 10 atomic percent, and z is greater than approximately 20 atomic percent.

14. The method of claim 13, wherein z is between approximately 23 and 30 atomic percent.

15. The method of claim 13, wherein the SAF structure is configured to provide a uniaxial anisotropy such that a kink field Hₖ of the bottom and top ferromagnetic layers is less than approximately 16 Oe.

16. The method of claim 13, wherein the ferromagnetic layers exhibit a magnetostriction λ, where λ is in the rang of −1×10⁻⁶<λ<1×10⁻⁶.

17. The method of claim 13, wherein forming the bottom ferromagnetic layer includes forming a layer having a thickness greater than approximately 20 Å, and forming the top ferromagnetic layer includes forming a layer having a thickness greater than approximately 20 Å.

18. The method of claim 13, wherein forming the bottom and top ferromagnetic layers includes co-sputtering films at least two different targets.

19. The method of claim 13, wherein forming the bottom and top ferromagnetic layers includes multilayering films using sputtering deposition.

20. A magnetic device with at least one magnetic layer comprising an amorphous CoFeB alloy characterized by (Co₁₀₀₋ₐFeₐ)_{100-z}B_{z}, where a is less than approximately 10 atomic percent, and z is greater than approximately 20 atomic percent.
